(19) United States
(12) Patent Application Publication
(10) Pub. No.: US 2014/0339295 A1
(43) Pub. Date: Nov. 20, 2014

(54) Method for Providing Instruction Manual for Using a Measuring Tool

(71) Applicant: Empire Level Mfg. Corp., Mukwonago, WI (US)

(72) Inventor: John Christianson, Waukesha, WI (US)

(73) Assignee: Empire Level Mfg. Corp., Mukwonago, WI (US)

(21) Appl. No.: 13/897,248

(22) Filed: May 17, 2013

(51) Int. Cl. G06F 17/30

(52) U.S. Cl. CPC G06F 17/30879
USPC 235/375

(57) ABSTRACT

A method for providing an instruction manual for using a measuring tool. The method includes the step of providing a tool, preparing a guide for using the tool, posting the guide on an Internet site. The guide includes a set of instructions for taking the measurements and a set of pre-calculated numbers corresponding to particular measurements. The tool includes a face surface with measurement markings thereon for taking measurements useable in geometric calculations. The Internet site with an Internet path leading thereto. The method includes the step of creating a barcode on the face surface which when scanned leads the user directly to the guide Internet site.

### FIELD OF THE INVENTION

This invention generally relates to hand tools. More specifically, this invention relates to a method for providing instruction manual for using a measuring tool such as rafter squares and the like.

### BACKGROUND OF THE INVENTION

Construction professionals use a variety of measuring tools. To insure proper perpendicularity and angularity for correct alignment of adjacent members, rafter squares, levels and gages are commonly employed. For example, carpenters frequently use framing squares, also known as rafter squares, of different types as a means of working more efficiently and accurately. For taking certain measurements correctly, the user of some measurement tools may need a guide for proper application of the tool and correct reading of the measurements. In many instances, the taking measurements then need to be either converted into another applicable measurement. Some conversions may require complex calculations. To simplify the use of such measurement tools, manufacturers provide an instruction manual which includes simple instructions for correct application of the tool and may include a set of tables with pre-calculated numbers of conversions for most commonly used measurements. Such set of instructions and additional calculation-related information is assembled into an instruction-manual booklet which accompanies the measuring tool.

Very often the instruction-manual booklet, which accompanies a new tool, is displaced or otherwise separated from the tool. The user, however, continues to require reference to the manual for using the tool as well for doing quick conversions by using the data provided in the manual. In such situations, the user may have to make an inconvenient trip to the location where the manual is stored. Most often, the used tries to contact the manufacturer for assistance in receiving a particular information. For many reasons such assistance may not always be available.

In some situations, work on a typical construction site is performed under various lighting conditions which may vary from bright sunlight to electric illumination. In such situations, even if the booklet is available, the user may not be able to read the small font in which the booklets most typically are printed.

It would be advantageous to have an instruction manual which is permanently attached to a tool and is continuously accessible and easily readable in various circumstances.

### SUMMARY OF THE INVENTION

The present invention relates to a method for providing a permanent and substantially continuous access to an instruction manual for using a measuring tool. The tool includes a face surface with measurement markings thereon for taking measurements useable in geometric calculations. The inventive method includes the step of preparing a guide for using the tool. The guide includes a set of instructions for taking the measurements and a set of pre-calculated data corresponding to particular measurements. The method includes the step of creating a non-removable marking on the face surface of the tool. The marking includes an encryption related to the guide such that the users guide permanently accompanies the measuring tool and that the user has substantially continuous access to the guide information even without a paper-copy of the guide.

In some embodiments, the measuring tool is a rafter square. The guide may include conversion tables for measurements used in roof construction.

The method may also include further steps of posting the guide on an Internet site with an Internet address leading thereto. In such embodiments, the encryption includes the Internet address leading the user directly to the guide Internet site. The marking may be a two-dimensional matrix barcode which, when optically read by an electronic device with an access to the Internet, connects such electronic device with the guide Internet site. In some embodiments, the guide Internet site is a page on an Internet site of a manufacturer of the tool. The guide may be a single electronic document on the Internet site of the manufacturer of the tool.

In certain embodiments, the face surface has an anodized layer. In some of such embodiments, the creating step is by application of a laser energy to oxidize the anodized layer thereby producing non-removable marking. The anodized layer may be dark and the non-removable marking(s) is/are substantially white thereby producing high-visibility marking.

In the embodiments where the measuring tool is a rafter square, the creating step includes creating non-removable substantially white measurement markings such as ruler and protractor.

The marking may be a two-dimensional matrix barcode which, when optically read by an electronic device with an access to the Internet, connects such electronic device with an Internet site including the guide. One example of such encryption is a Quick Response (QR) code which is an optically machine-readable matrix image.

In use of the present invention, the user my use many different types of electronic device which have access to the Internet and are adapted for scanning encryptions such in the form of a barcode. One example of such devices is a multi-function portable telephones known as “smart phones” which are widely used due to their versatility of features.

The non-removable substantially white markings are formed by oxidized aluminum with the substantially white color resulting from formation of aluminum oxide. The application of laser energy also preferably forms grooves in the surface of the metal plate. The depth of the grooves is selected by programming a controller which contains programmable information regarding the laser application. Because the grooves and the white-color markings are formed by application of the laser energy, such process substantially eliminates any displacement of the metal at the plate surface. This, along with the programmable laser controller, results in highly accurate measurement markings. Furthermore, in the absence of any color coating, the white markings are substantially permanent due to the change in a chemical state of the metal plate surface. The white markings are highly visible on dark anodized layer. The white-on-dark contrast of the markings is maintained even after an extended use with repetitive rubbing.

### BRIEF DESCRIPTION OF THE DRAWINGS

FIG. 1 are perspective views of both sides of a rafter square made according to a method of the present invention.

FIG. 2 is an enlarged fragmentary view of the rafter square of FIG. 1 showing a QR code on a face surface thereof.

FIG. 3 is a schematic view of a smart phone in the process of scanning the QR code.

FIG. 4 is an exemplary page from a users manual accessible by using the inventive method, the page is titled “Using the Rafter Square.”

FIG. 5 is another exemplary page from the users manual, listing instructions for using the rafter square.

FIGS. 6 and 7 is another exemplary page from the users manual, the page showing how to use the rafter square.

FIG. 8 is yet another exemplary page from the users manual, the page showing a set of conversion tables.

### DETAILED DESCRIPTION OF EXEMPLARY EMBODIMENTS

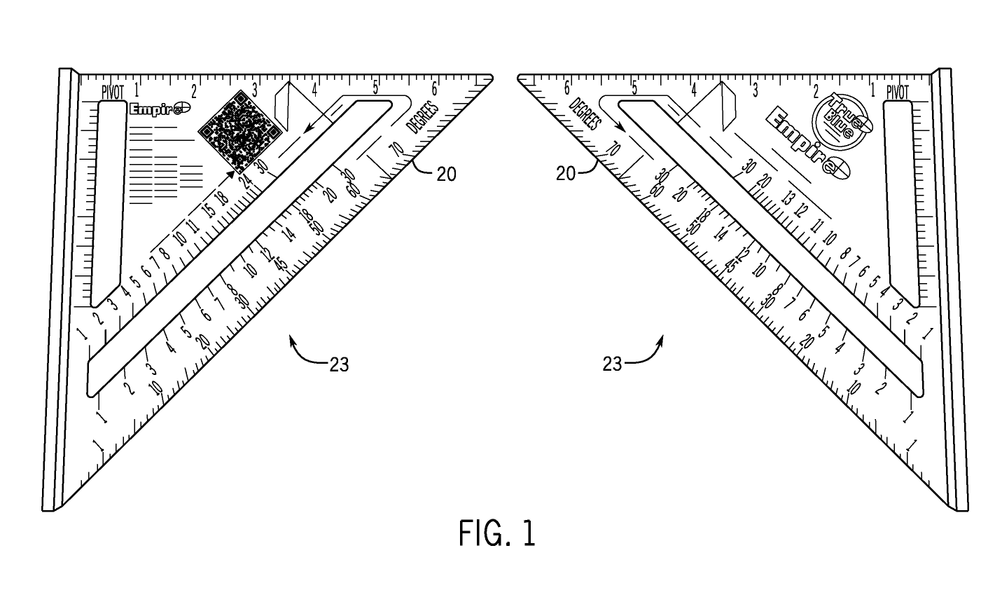

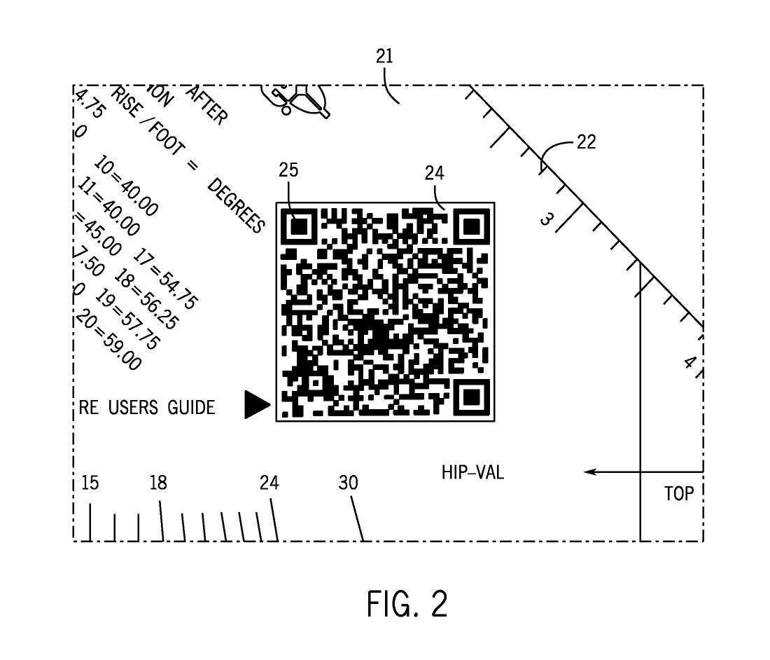

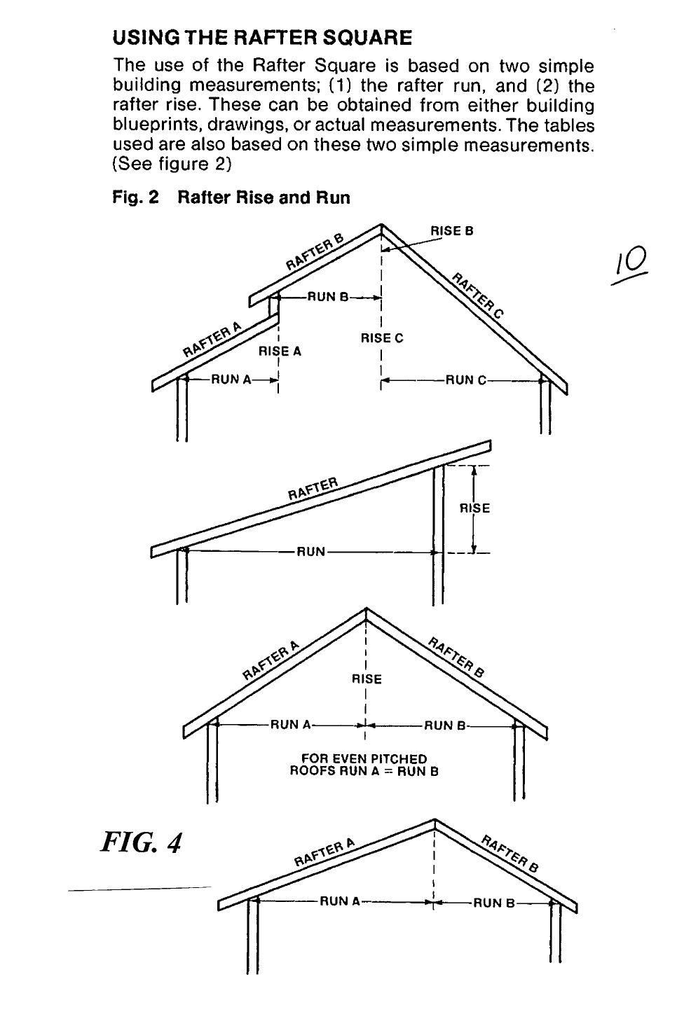

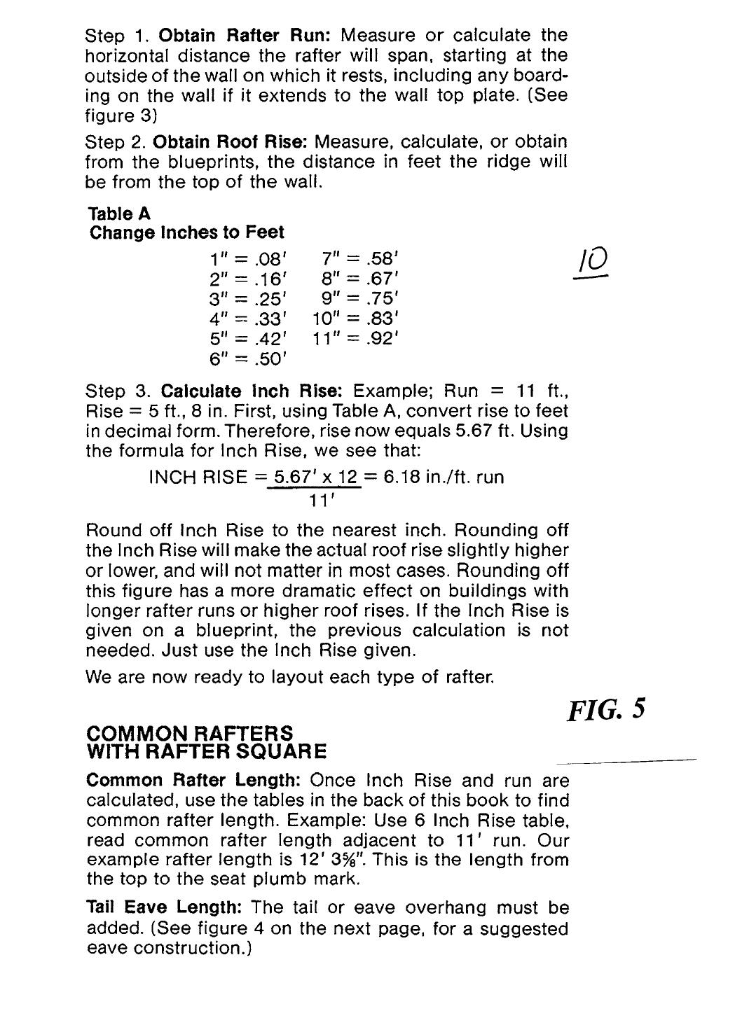

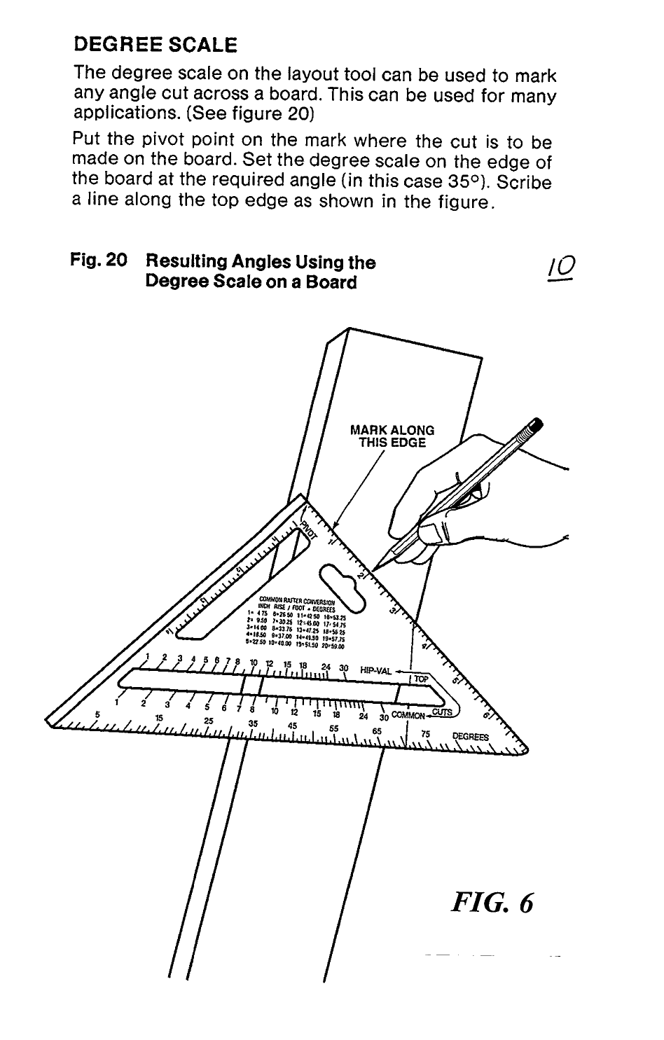

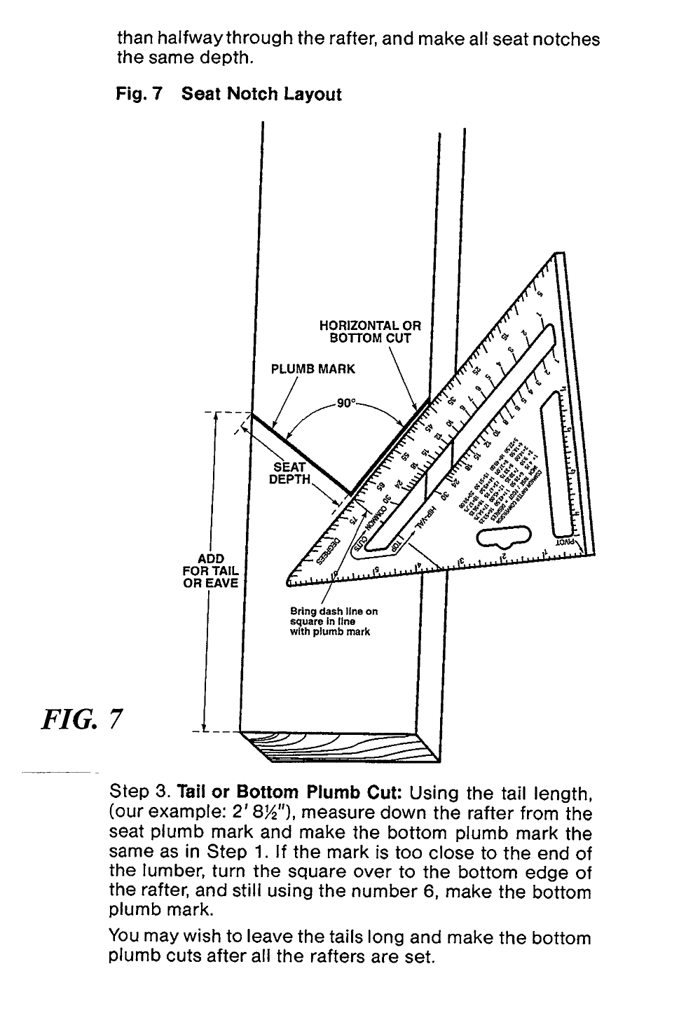

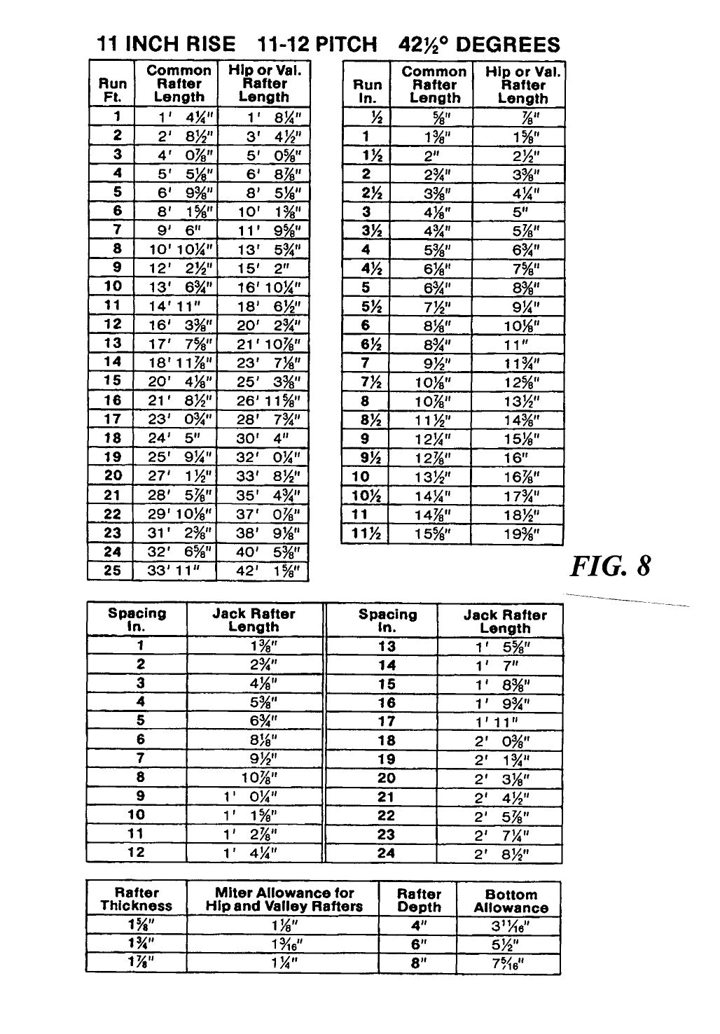

FIGS. 1-3 illustrate the present invention related to a method for providing a permanent and substantially continuous access to an instruction manual 10 for using a measuring tool 20. The tool includes a face surface 21 with measurement markings 22 thereon for taking measurements useable in geometric calculations. FIGS. 1 and 2 illustrate rafter square 23 which is one example of tool 200 of the present invention. The inventive method includes the step of preparing guide 10 for using tool 20. As shown in FIGS. 4-8, guide 10 includes a set of instructions for taking the measurements, as seen in FIG. 4-7, and a set of pre-calculated data corresponding to particular measurements, as seen in FIG. 8. FIG. 2 best shows a marking 24 created on face surface 21 of tool 23. Illustrated marking 24 is a QR code which includes an encryption related to guide 10 such that users guide 10 permanently accompanies measuring tool 20 and that the user has substantially continuous access to the guide information even without a paper-copy of the guide.

Guide 10 is posted on an Internet site with an Internet address leading thereto. FIG. 2 shows encryption 25 which includes the Internet address—http://www.empirelevel.com/images/products/squares/17453.pdf—which leading the user directly to the guide Internet site. Such Internet site is a webpage on a website of Empire Level Mfg. which is a manufacturer of tool 23.

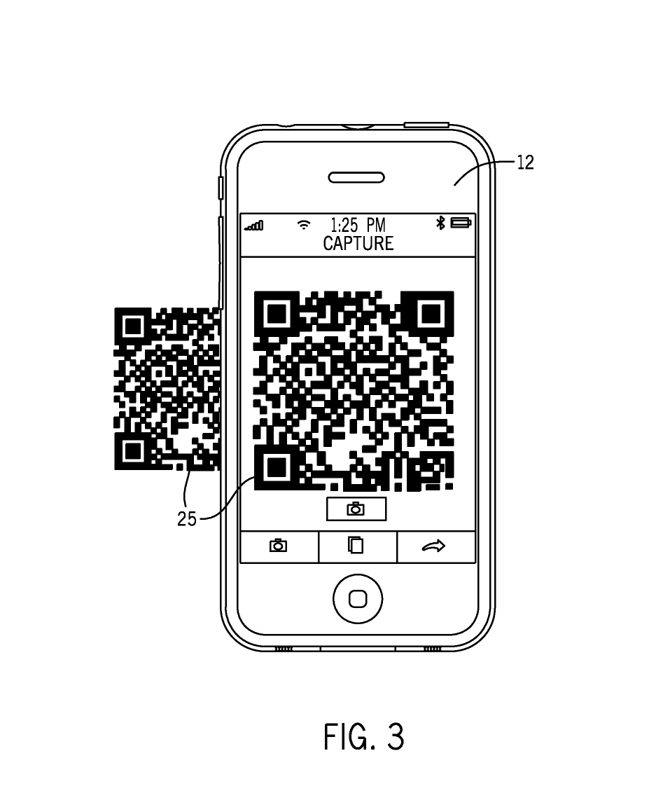

FIG. 3 schematically illustrates how two-dimensional matrix barcode 25 is being optically read by a “smart phone” with an access to the Internet. Such smart phone has the ability to interpret the scanned information encrypted in code 25 and to connect directly with the guide Internet site.

The accuracy of interpretation of information encrypted in QR codes permits the user to easily access the webpage with the instruction manual information directly without the need for searching through other webpages on the manufacturer's website. The scanning with a smart phone also permits access to the instruction manual in nearly any lighting or other conditions. Once the smart phone accessed the web page containing the instruction manual, the user may get to the applicable page by using the enlargement features of the smart phone for clear and correct reading of the instruction information or calculation data. This is advantageous in comparison with simple typing-in of a lengthy and sometimes complicated Internet address for a specific webpage.

FIGS. 1 and 3 show face surface 21 of rafter square 23 having a dark anodized layer. Marking 24 is created by application of a laser energy to oxidize the anodized layer thereby producing non-removable marking which is substantially white which provides high-visibility of the markings.

FIG. 1 also shows that rafter square 23 includes non-removable substantially white measurement markings 22 such as ruler and protractor also created by application of a laser energy.

While the principles of the invention have been shown and described in connection with specific embodiments, it is to be understood that such embodiments are by way of example and are not limiting.

1. A method for providing an instruction manual for using a measuring tool, the method comprising:
providing a tool including a face surface with measurement markings thereon for taking measurements useable in geometric calculations;
preparing a guide for using the tool, including a set of instructions for taking the measurements and a set of pre-calculated numbers corresponding to particular measurements;
on the face surface, creating a marking which includes an encryption related to the guide,
whereby the users guide permanently accompanies the measuring tool such that the user has substantially continuous access to the guide information even without a paper-copy of the guide.

2. The method of claim 1 wherein the measuring tool is a rafter square.

3. The method of claim 2 wherein the guide includes conversion tables for measurements used in roof construction.

4. The method of claim 1 including further steps of:
posting the guide on an Internet site with an Internet address leading thereto; and
the encryption includes the Internet address leading the user directly to the guide Internet site.

5. The method of claim 4 wherein the guide is a single electronic document on an Internet site of a manufacturer of the tool.

6. The method of claim 4 wherein the marking is a two-dimensional matrix barcode which, when optically read by an electronic device with an access to the Internet, connects such electronic device with the guide Internet site.

7. The method of claim 6 wherein the guide Internet site is a page on an Internet site of a manufacturer of the tool.

8. The method of claim 7 wherein the guide is a single electronic document on the Internet site of the manufacturer of the tool.

9. The method of claim 1 wherein:
the face surface has an anodized layer; and
the creating step is by application of a laser energy to oxidize the anodized layer thereby producing the non-removable marking

10. The method of claim 9 wherein the measuring tool is a rafter square.

11. The method of claim 10 wherein the creating step includes creating non-removable measurement markings such as ruler and protractor.

12. The method of claim 11 wherein the anodized layer is dark and the non-removable marking(s) is/are substantially white.

13. The method of claim 11 wherein the guide includes conversion tables for measurements used in roof construction.

14. The method of claim 1 wherein the marking is a two-dimensional matrix barcode which, when optically read by an electronic device with an access to the Internet, connects such electronic device with an Internet site including the guide.

15. The method of claim 14 wherein the guide Internet site is a page on an Internet site of a manufacturer of the tool.

16. The method of claim 15 wherein the guide is a single electronic document on the Internet site of the manufacturer of the tool.

17. A method for providing an instruction manual for using a measuring tool, the method comprising:
providing a tool including a face surface with measurement markings thereon for taking measurements useable in geometric calculations;
preparing a guide for using the tool, including a set of instructions for taking the measurements and a set of pre-calculated numbers corresponding to particular measurements;
posting the guide on an Internet site with an Internet path leading thereto; and
creating a barcode on the face surface which when scanned leads the user directly to the guide Internet site.

18. The method of claim 17 wherein the measuring tool is a rafter square.

19. The method of claim 18 wherein the guide includes conversion tables for measurements used in roof construction.

20. The method of claim 17 wherein the guide is a single electronic document on the Internet site of the manufacturer of the tool.
